(19) United States
(12) Patent Application Publication
(10) Pub. No.: US 2017/0181449 A1
(43) Pub. Date: Jun. 29, 2017

(54) PIZZLE STICK KABOB PET TREAT

(71) Applicant: Spectrum Brands, Inc., Middleton, WI (US)

(72) Inventors: Stacey Harbour, Dardenne Prairie, MO (US); Casey Sims, Saint Louis, MO (US); Joseph Christopher Carley, Blacksburg, VA (US); Marc Kreamer, Delray Beach, FL (US)

(21) Appl. No.: 15/390,973

(22) Filed: Dec. 27, 2016

Related U.S. Application Data
(60) Provisional application No. 62/271,858, filed on Dec. 28, 2015.

(51) Int. Cl. A23K 40/30; A23K 50/42; A23K 10/26

(52) U.S. Cl. CPC A23K 40/30; A23K 10/26; A23K 50/42

(57) ABSTRACT

A process for making pet food treats including a base material, the treats themselves and a processing system for making the treats. The auxiliary ingredients are combined to form a foodstuffs mixture. Portions of the foodstuffs mixture are formed. The portions of foodstuffs mixture are positioned on a chew stick that comprises pizzle stick. The pet treat gives the appearance of a grilled shish kabob, where the meat portions are meant for initial taste, while the chew stick will take provide the dog with a longer-lasting chewing portion.

### CROSS-REFERENCE TO RELATED APPLICATIONS

This application claims the benefit of U.S. Provisional Application No. 62/271,858, filed Dec. 28, 2015, which is incorporated herein by reference in its entirety.

### INTRODUCTION

One of the main attributes of chew type products is a toughness and flexibility to the point where it takes the dog a long time to consume the product. A great majority of the chew style products include rawhide. While rawhide is used as a base material, it has limited acceptability because it does not maintain a dog's interest. Manufacturers have attempted to solve this problem of reduced acceptability by incorporating numerous ingredients and processing techniques into the manufacture of rawhide-based chews for dogs, such as incorporating meat in the middle of a rawhide stick.

Despite this, the basic problem remains. As ingredients or processing techniques are utilized with rawhide to increase palatability, they typically weaken the basic structure of the rawhide and produce a less acceptable product from the standpoint of extended chew time. Further, the rawhide stick does not provide a visually appealing treat for dog. The pet treat also does not give the pet owner a visually acceptable reaction when purchasing the pet treat. What is needed is a pet treat that provides a visually appealing product that stimulates a human to purchase the pet treat. What is needed is a pet treat that provides a palatable product for a pet and can provide an initial taste reward, but also gives the dog a chew portion for sustained pet treat duration.

The prior art demonstrates a long history of utilizing rawhide in dog chews, Fisher (U.S. Pat. No. 2,988,045) demonstrated the basic techniques of how rawhide can be separated at the tannery and split into layers that can be formed into shapes followed by dehydration to produce a shelf-stable rawhide chew for dogs. Perlberg (U.S. Pat. No. 6,223,693) demonstrates a method of soaking rawhide in a humectant and soft edible binder to produce a flexible edible chew. Twain (U.S. Pat. No. 6,425,348) taught a method for producing a chewable pet shelter from rawhide which incorporated chemical flavoring which would appeal to the pet.

Kirch (U.S. Pat. No. 6,840,196) demonstrates a pet chew produced by folding a first sheet of rawhide around a second sheet of rawhide. The second sheet is impregnated with a flavoring and protrudes from under the first sheet of rawhide. This system served to increase the palatability of the chew while at the same time reduced the incident of rug staining which can be a problem when the flavoring is present on the surface of the product.

Hingst (U.S. Pat. No. 6,895,900) disclosed a combination rawhide and pigskin product where sheets of rawhide and pigskin are sandwiched or intertwined together to form a treat with improved flavor. Jia (U.S. Pat. No. 6,935,275) teaches a method for producing a dog treat by rolling a precut and flavored rawhide piece into a cylinder with strips of hide extending from the outer ends of the cylinder.

Some of the most commercially successful products utilizing rawhide as dog treats have taken the approach of incorporating a meat fraction in conjunction with the rawhide to significantly increase the palatability of the chew. Sherrill (U.S. Pat. No. 5,673,653) disclosed a product and process of wrapping jerky sheets on the inside of a roll of rawhide. The jerky fraction protruded from the ends and the horizontal seam of the outside layer so that the dog could quickly be subjected to the flavor of the dehydrated meat fraction. This product is commercially known as a “Dingo” treat. Only a small portion of meat fraction however is initially available to the dog and the manufacturing method of rolling rawhide within sheets of jerky significantly reduce the quantity of meat that can be incorporated on a dry weight basis.

Andersen (U.S. Pat. No. 6,277,420) demonstrates a method of making a preformed rawhide tube and depositing a shelf-stable liquid meaty filling into the cavity of the tube which gels and then forms a solid matrix on the inside of the rawhide. While this system incorporates large ratios of meaty filling fraction to rawhide, the chew time is somewhat reduced by the high moisture present in the system.

Brown (U.S. Pat. No. 6,886,496) has attempted to solve this problem by producing a pre-extruded dried meaty log that could be placed inside of a rolled rawhide cylinder. While this would result in a somewhat extended chew time over many of the earlier treats, a limited fraction of meat is available on the surface of the final chew to maintain a dog's interest for an extended period of time. Further, the initial meat reward may not be sufficient to entice the dog to finish the treat leaving a remnant of the treat behind.

Anderson et al (U.S. Pat. No. 8,479,687) teaches braiding or weaving together combinations of preformed rawhide ropes with fresh cleaned penis segments. Anderson specifically teaches that a minimum of three strands must be used for the weaving step and can be composed of any ratio of rawhide ropes to bull or steer penises, forming a relatively uniform stick-shaped pet chew. However, Anderson does not provide a chew with a soft flavor component that will provide the animal with an immediate satisfaction without requiring the animal to continually gnaw on the chew.

Yet there is nothing in the prior art that provides a dry outer flavor portion for initial flavor enhancement, which also comprises a pizzle chew for a secondary flavor and sensory enhancement for a pet. The pet treat being sized to provide an intermediary pet treat that is more substantial than a “reward treat,” (i.e. dog biscuit) but will take less time to consume when compared to a classic rawhide bone.

Pizzle Stick Kabob Pet Treat

A composition and process for making pet food treats is described herein. Plant material (plant base) and/or meat material (meat base) (collectively referred to as base material) and auxiliary ingredients are combined to form a meat and/or plant mixture (hereinafter foodstuffs mixture). The foodstuffs mixture is formed into portions. The portions of the foodstuffs mixture are positioned on a chew stick that comprises dehydrated bovine penis (hereinafter “pizzle”). The pet treat gives the appearance of a grilled shish kabob, where the foodstuffs portions are meant for initial taste and the chew stick will provide the dog with a longer-lasting chewing portion.

### BRIEF DESCRIPTION OF THE DRAWINGS

FIG. 1 illustrates a process of making a foodstuffs mixture.

FIG. 2 illustrates a process of making a chew stick.

FIG. 3 illustrates a process of making a pet chew.

FIG. 4 illustrates a process of drying a pet treat.

FIG. 5 illustrates a process of inspecting a pet treat prior to shipment.

FIG. 6 illustrates one embodiment of a pet treat manufacturing process.

FIG. 7 is a perspective view of a pet treat.

### DETAILED DESCRIPTION

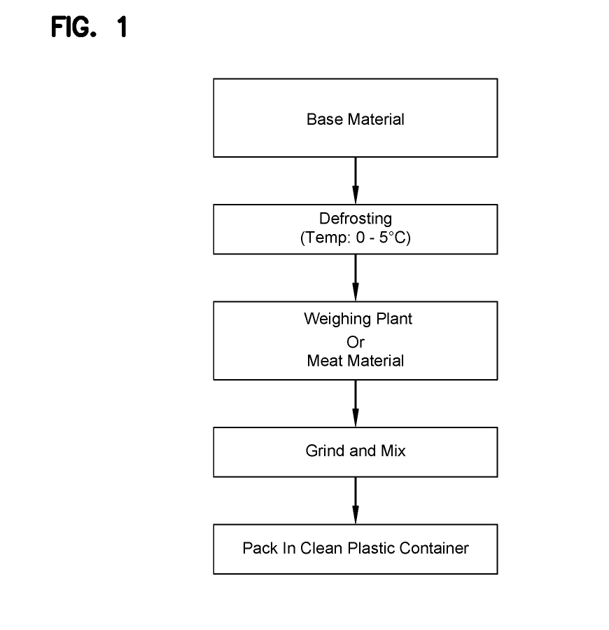

The method of making a pet treat is described herein. FIGS. 1-6 illustrate schematic depictions of various aspects of the methods of making a pet treat. The method comprises forming a foodstuffs mixture into portions and positioning one or more portions on a chew stick and drying the pet treat.

As shown in FIG. 1, the meat base is made from animal meat. The animal meat may be fresh, dehydrated, powdered, and extract or frozen. The frozen animal meat is defrosted at about 0 degrees Celsius to about 5 degrees Celsius. Once the animal meat is defrosted, the animal meat is weighed. Once the predetermined amount of animal meat is weighed, the meat is placed in a grinder, the animal meat(s) is ground and mixed with the specific desired ratio of animal meat(s) and stored in a container as a meat base. It should be noted that the meat base may be frozen for later use, or may be used immediately after the meat base is prepared. Further, one should appreciated the meat base can include boneless chicken, duck, chicken liver beef, pork, lamb, goat, horse, buffalo, venison, elk, moose, chicken, turkey, fish, or any other seafood, or any combination of two or more thereof. In some example embodiments the meat may comprise boneless chicken, duck, chicken liver and combinations thereof . The term “meat” associated with “meat base” and “foodstuffs mixture” are intended to encompass portions of animals, mammal and non-mammal, that can be used for a pet treat. This includes but is not limited to soft tissue, internal organs, cartilage and bone.

In one embodiment of the invention, chicken meat is used as a meat base. Chicken meat can include, for example, necks, breasts, or backs, or any combination of two or more thereof, with or without cartilage and/or bone ground to small sizes (i.e., emulsified). Chicken meat can include mechanically separated chicken (MSC). Chicken meat can also include a mixture of boneless or bone-in chicken, mixed together in various portions. The chicken meat is used in an amount of about 6-35% by weight of the foodstuffs mixture. It should be appreciated that the other animal sources, including various sections of the animal can be used to provide a final taste or consistency for the meat. In embodiments where other meat sources are used, the total meat content is 6% to 35% by weight of the foodstuffs mixture.

Still referring to FIG. 1, the plant base is made from a plant base material, such as a fruit, vegetable, vegetable protein, fruit extract, vegetable extract and combinations thereof that can be consumed by a domestic pet. The plant material may be fresh, dehydrated, powdered, an extract or frozen. In embodiments where the plant material is frozen the plant material is defrosted at about 0 degrees Celsius to about 5 degrees Celsius. Once the plant material is defrosted, the plant material is weighed. Once the predetermined amount of plant material is weighed, the plant material is placed in a grinder, the plant material(s) is ground and mixed with the specific desired ratio of plant material (s) and stored in a container as a plant base. It should be noted that the plant base may be frozen for later use, or may be used immediately after the plant base is prepared. In one example embodiment, the plant base does not include any meat product, such as beef, pork, lamb, goat, horse, buffalo, venison, elk, moose, bone-in chicken, turkey, fish, or any other seafood.

A plant base material, as used herein, means a fruit, vegetable, vegetable protein, fruit extract and vegetable extract that can be consumed by a domestic pet, such as a dog. The plant based material may be produced in various sizes or shapes. In particular, following mixture, the plant base may be cut or shaped to look like meat portions on a shish kabob.

In one embodiment of the invention, the plant base may include fruits such as, apple, apricot, banana, blackberry, blackcurrant, blueberry, coconut, cherry, cherimoya, date, durian, fig, feijoa, gooseberry, grape, grapefruit, jackfruit, jambul, kiwifruit, kumquat, lemon, lime, loquat, lychee, mango, mangosteen, melon, cantaloupe, honeydew, watermelon, nectarine, orange, passionfruit, peach, pear, plum, prune, pineapple, pomegranate, pommelo, raspberry, rambutan, redcurrant, satsuma, strawberry, tangerine, ugli fruit and combinations thereof.

The plant base may include vegetables such as, artichoke, asparagus, avocado, bamboo shoots, bean sprouts, beans, beet, endive, bell pepper, broccoli, brussels sprouts, cabbage, calabaza, carrot, cauliflower, celery, cucumber, radish, eggplant, garlic, fiddlehead, galangal, ginger, beet greens, collard greens, dandelion greens, kale, mustard, spinach, Swiss chard, turnip greens, Jerusalem artichoke, jicama, lettuce, mushrooms, okra, onion, parsley, parsnip, peas, peppers, plantain, pumpkin, radicchio, radish, rutabaga, spinach, squash, sweet potato, tomato, turnip, water chestnut, yams, and combinations thereof.

Pet treat may also include a starch composition which comprises any carbohydrate of natural or vegetable origin. The starch may include amylose and/or amylopectin and may be extracted from plants, including but not limited to potatoes, rice, tapioca, corn and cereals such as rye, wheat, and oats. The starch may also be extracted from fruits, nuts and rhizomes, or arrowroot, guar gum, locust bean, arracacha, buckwheat, banana, barley, cassava, konjac, kudzu, oca, sago, sorghum, sweet potato, taro, yams, fava beans, lentils and peas. The starch may be present between about 6-80% including but not limited to 10%, 15%, 20%, 25%, 30%, 35%, 40%, 45%, 50%, 55%, 60%, 65%, 70%, 75% and 80%. Alternatively, the starch composition may be at least 10%, 15%, 20%, 25%, 30%, 35%, 40%, 45%, 50%, 55%, 60%, 65%, 70%, 75% or 80%.

In some embodiments, starch is used to provide structural support to the foodstuffs mixture. The starch employed herein may be raw starch, which may be understood as starch that has not seen a prior thermal molding history, such as extrusion or other type of melt processing step. The raw starch itself may also be native, which may be understood as unmodified starch recovered in the original form by extraction and not physically or chemically modified. The raw starch may also be in powder form of varying particle size, which may be understood as milled and/or pre-sifted. It should be understood that the raw starch may also have varying degrees moisture present. The starch composition may include cellulose. The cellulose may be, for example, a long-chain polymer of polysaccharide carbohydrate. The cellulose may also be derived or extracted from plants. The cellulose may be incorporated into the starch composition between about 1-10% by weight of the starch composition.

Additionally, herbs, herbal extracts, vitamins, minerals, yeast products, soy products, may be incorporated into the plant base. Further, the plant base may also include food sources that provide phytochemicals. A non-exclusive list phytochemicals include: carotenoids, lycopenes, beta cryptozanthin, flavonoids, indoles, sulforaphane, isoflavones, allicin, genistein, polyphenols, anthocyanins, limonoids, sterols, capsaicin, elegiac acid and lignans.

In one example embodiment carotenoids are included in the plant base. In at least this example embodiment the carotenoids are included from a plant selected from a group consisting of carrots, cantaloupe, papaya, pumpkin, squash, sweet potatoes, broccoli, dried apricots, asparagus, kale, green leafy vegetables and combinations thereof. In related embodiments lycopenes are included in the plant base. The lycopenes are added with the addition of plants selected from a group consisting of tomatoes, tomato paste, tomato juice, guava, pink grapefruit, watermelon and combinations thereof. In other related embodiments, beta cryptozanthin are included in the plant base. Beta cryptozanthin are found in plants such as tangerines, papaya, oranges, peaches, mangoes, nectarines and combinations thereof.

In other example embodiments flavonoids extracted from plants such as soy, green tea, tomatoes, sweet potatoes, cruciferous vegetables such as broccoli, cabbage, brussels sprouts, mustard greens, kale, and cauliflower, citrus fruits, onions and combinations thereof can be used in the plant base. In other example embodiments, indoles and sulforaphane, which are commonly found in cruciferous vegetables are added to plant base. Examples of cruciferous vegetables include, but are not limited to cauliflower, cabbage, garden cress, bok choy, broccoli and brussels sprouts. in other related embodiments, isoflavones are included in plant base. Isoflavones are commonly found in legumes, such as beans, peas and lentils and soy products. In other related embodiments, allicin is added to the plant base, which can be found in plants such as onions and garlic In example embodiments genistein is added through the addition of soy products, such as tofu. In other example embodiments, polyphenols can be added through the addition of green tea.

In yet other related embodiments, anthocyanins found in plants such as wild blueberries, bilberries and black berries can be included in plant base. Limonoids, found in citrus fruits such as clementine, grapefruit, kumquat, lemon, lime, mandarin, orange, tangerine and the like can also be added to plant base. In other embodiments, sterols from cruciferous vegetables, cucumbers, squash, sweet potatoes, soy foods, eggplant, whole grains, tomatoes and the like are included in plant base. In embodiments where the addition of capsaicin is desired, the phytochemical can be added by including chili peppers. Similarly, in embodiments where elegiac acid is desired strawberries can be included in plant base. The addition of lignans, can be achieved by the addition of nuts and seeds. It should be appreciated that the addition of certain plants will include more than one phytochemical listed herein. Further, extract(s) of the aforementioned plants can be added to specifically add a desired phytochemical or combination of phytochemicals to the plant base.

Other sources of important nutrients for animals may also include seaweed, kelp, blue green algae, spirulina, Irish moss, dulse, nori, kombu, wakeme, alfalfa, fenugreel seed, wheatgrass, barleygrass and marine phytoplankton.

The plant material is used in an amount of about 6% to 90% of the foodstuffs mixture. In one example embodiment, the plant material is used in an amount of about 6-35% by weight of the foodstuffs mixture. It should be appreciated that the other plant sources, including various extracts, can be used to provide a final taste or consistency for the foodstuffs mixture. In embodiments where other plant sources are used, the total plant content is 6% to 90% by weight of the entire foodstuffs mixture. Further, one should appreciated that although FIG. 1 notes plant material for use in forming the plant base it may optionally comprise beef, pork, lamb, goat, horse, buffalo, venison, elk, moose, chicken, turkey, fish, or any other seafood, or any combination of two or more thereof.

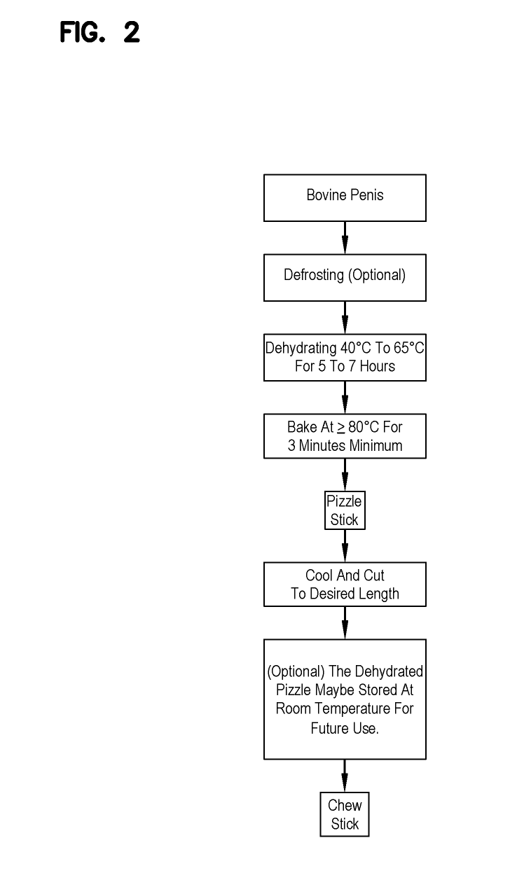

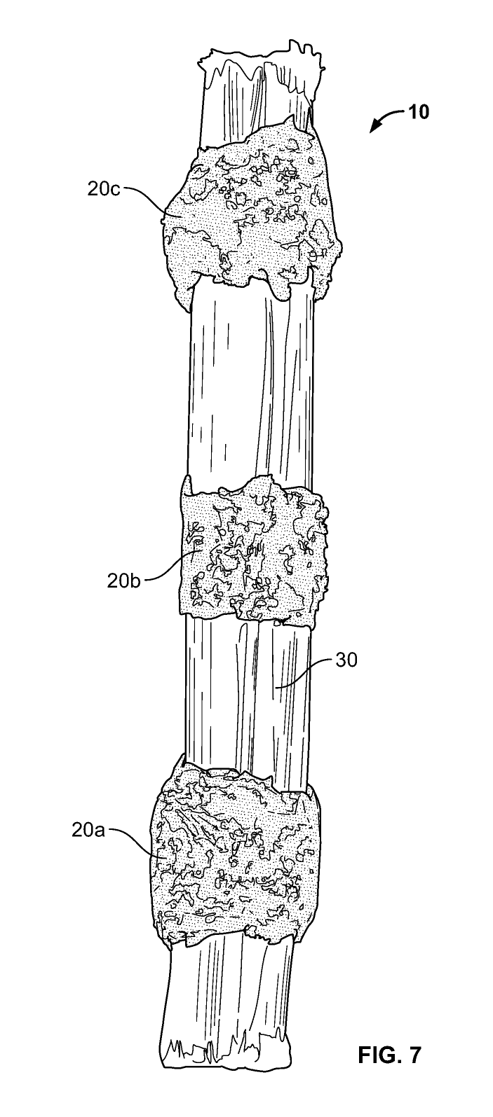

The process of forming a chew stick includes, but is not limited to the use of rawhide, or other similar materials to form an elongated section. It should be appreciated that the chew stick, as described herein may be made from several processes available to one skilled in the art; for example, extrusion, molding and the like are within the scope of the invention. In one example embodiment, the chew stick is prepared by shaping a piece of rawhide to form an elongated chew. As shown in FIG. 2 (illustrated in FIG. 7) the chew stick is prepared by shaping a piece of pizzle to form an elongated chew. Pizzle is formed from a bovine penis that is generally obtained frozen, although fresh bovine penis can also be utilized. In embodiments where the bovine penis is frozen the bovine penis is defrosted. The bovine penis is then dehydrated in an oven at 40 degrees Celsius to 65 degrees Celsius for 5 to 7 hours. Prior to dehydration, the bovine penis may optionally be stretched to alter final length, width and curvature of the pizzle stick. In other related preparation methods, pizzle sticks are obtained by taking bovine penises and removing any unwanted fat or membranes from the penis. In related embodiments, the pizzle stick can be made from bovine penis that is cut lengthwise, into halves or quarter sections. Segmentation of the bovine penis prior to dehydration may provide an alternative option to prepare the chew stick.

The penises, or penis segments, are dehydrated to allow for the outer surface to harden using technique one of skill in the art would readily understand. One such technique includes blowing hot air for a period of time to achieve a specific moisture content. Typical dehydration parameters include a moisture content of between 2-5%, 2-10%, 5-10%, 10-15% and 15-20%. In related embodiments the moisture content is less than 18%. Once the bovine penis has achieved the desired moisture content, the pizzle stick can be further processed, by cutting to desired lengths or splitting to desired thickness.

Once the dehydration step is finished the bovine penis will be baked at a temperature of greater than or equal to 80 degrees Celsius. Once the bovine penis is baked, the final product results in a pizzle stick. The pizzle stick is then optionally cut and sized to form a chew stick. One example length is between 2-5 inches in length. In another related embodiment the pizzle stick is length is in a range of 2-4 inches. In another related embodiment the pizzle stick is no more than 4 inches in length. It is important to note that although pizzle sticks that are removed from the oven may be used once cooled to a workable temperature, they can also be stored at room temperature for future use. In other related embodiments, the cut pizzle sticks may be optionally twisted. The pizzle stick may also be flavored according to one of the processes described herein.

When at least two pizzle stick portions is desired the second pizzle stick is placed upon the first pizzle stick in the same general orientation, as described, the two pizzle sticks are twisted together to make a multi-component chew stick. Once the pizzle sticks are twisted together, they are dehydrated. In one example embodiment, an additional drying step is performed where the chew stick is dried in an oven at 40 degrees Celsius to 65 degrees Celsius for 4 to 5 hours. The chew sticks are allowed to cool to allow for ease in handling. As described above, the dried pizzle stick is removed from the oven, where the pizzle stick (now designated as a chew stick) is further processes or stored for later use.

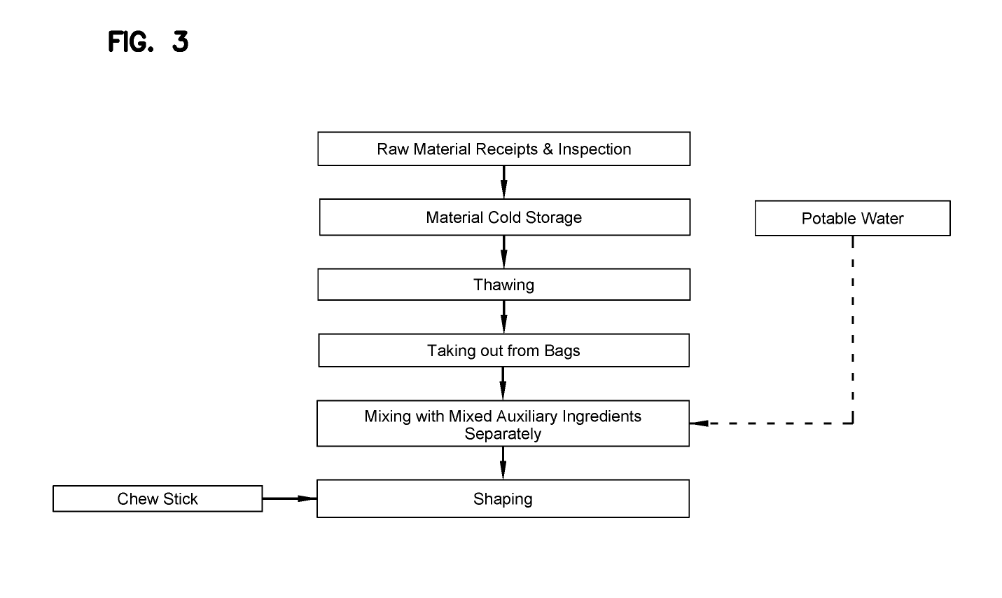

FIG. 3 describes one example method of receiving, storing and processing base material to form a foodstuffs mixture. To that end, base material can be stored at sub-zero temperatures, although fresh base material is also within the scope of the invention. The frozen base material is ready for further processing by thawing the base material. In some example embodiments, base material is thawed using a microwave. Alternatively, the base material can be thawed by other devices known by one of ordinary skill in the art. One such alternative device is a tempering device.

The frozen containers (i.e. bags) of base material are thawed and the base material is placed in a tumbler to begin the process of forming a foodstuffs mixture. Once the base material begins the tumbling process, the base material is combined with auxiliary ingredients forming a foodstuffs mixture. The base material can be used in an amount between about 30% and about 90% by weight of the foodstuffs mixture, for example about 60% by weight of the foodstuffs mixture. In some example embodiments, the base material and auxiliary ingredients can optionally be subjected to a vacuum to form a homogeneous foodstuffs mixture. The vacuum can remove entrapped air and can provide a more dense and homogenous blend. The vacuum can be applied at a level from about 0 to about 30 mm/Hg.

The foodstuffs mixture is prepared by mixing the base material with auxiliary ingredients that may include a binding agent, a salt, a sugar, an acid, a mold inhibitor, a flavoring, an aroma compound, a coloring compound, or any combination of two or more thereof.

The binding agent can be used in an amount between about 10% and about 75% by weight of the foodstuffs mixture. In one example embodiment the binding agent is about 20% by weight of the foodstuffs mixture. The type and amount of binding agent can be selected so that the resulting product is not sticky and no residue is left on the pet owners' finger-tips or household's surfaces, such as carpets. For example, the binding agent can be added to “buffer” or to absorb fat content in the foodstuffs mixture. The binding agent can also facilitate the blending of the various ingredients and allow the foodstuffs mixture to hold a shape prior to being dried.

The binding agent can include, but is not limited to, oat flour, soy flour, wheat flour, rice flour, potato flour, corn flour, rye flour, buckwheat flour, chestnut flour, chickpea flour, atta flour, pea flour, bean flour, amaranth flour, arrowroot flour, taro flour, cattail flour, acorn flour, sorghum flour, or tapioca flour, or a combination of two or more thereof. The flour, in this case wheat flour, is incorporated in amount of no more than 25% by weight of the foodstuffs mixture.

The aroma compound or flavoring compound, provide palatability enhancement respectively and include, but are not limited to, garlic (e.g., garlic concentrate, garlic oil, garlic powder, garlic aroma), onion (e.g., onion concentrate, onion oil, onion powder, onion aroma), natural smoke flavor, hickory, mesquite, anchovy, chicken, lobster, tikka, tandoori, parsley, spinach, saffron, digestive (liquid stomach contents of an animal, e.g., chicken), phosphate, yeast, or enzymatic liver (pork, turkey or chicken), or any derivative thereof, or any combination of two or more thereof. Additionally salt may be added to enhance flavor and can also provide particle binding in forming foodstuffs mixture.

The aroma compound or flavoring compound can be used in an amount between about 0% and about 5% by weight of the foodstuffs mixture, for example less than about 1% by weight of the foodstuffs mixture. The coloring compound can be used in an amount between about 0% and about 4% by weight of the foodstuffs mixture, for example less than about 1% by weight of the foodstuffs mixture. Flavoring compounds can be used in an amount between about 0% and about 0.5% by weight of the foodstuffs mixture, for example about 0.25% by weight of the foodstuffs mixture. Coloring compounds provide cosmetic enhancement respectively and include, but are not limited to, caramel coloring, malliouse, allura red AC, annatto, astaxanthin, betanin or beetroot red, blue 2, brilliant black BN, brilliant blue FCF, brown FK, canthaxanthin, carmine, carotene, Color Blue, curcumin, erythrosine, orange number 1, iron oxide, orange B, ponceau 6R, red 40, red 2G, saffron, sunset yellow FCF, tartrazine, titanium dioxide, turmeric, yellow 5, yellow 2, or any combination of two or more thereof.

The humectant can be used to reduce water activity. Water activity is a measure of the availability of water in a food for microbial growth such as molds. Water activity is a primary method of controlling antimicrobial or mold growth. One example range of water activity is an aW value of less than 0.7. The humectant including sugar, or sugar alcohols can be used in an amount between about 0% and about 20% by weight of the foodstuffs mixture, for example about 15% to 18% by weight of the foodstuffs mixture. The humectant, can include, but is not limited to fructose, dextrose, maltodextrin, honey, high-fructose corn syrup, maltose, brown sugar, coconut sugar, date sugar, sucanat, molasses, turbinado sugar, dextrin, glucose, sucrose, sucralose, glycerin or any derivative thereof, or any combination of two or more thereof.

The foodstuffs mixture may also include a mold inhibitor. A non-exclusive list of mold inhibitors include, but is not limited to, potassium sorbate, cultured whey, calcium propionate, cultured dextrose, cultured yeast, benzoic acid, acetic acid, or plum powder, or any derivative thereof or any combination of two or more thereof.

A moisturizing compound can be used in a range of between 2% and 20%. For example, a moisturizing compound, such as water will aid in formation of the foodstuffs mixture. For example, the moisture content of the foodstuffs mixture may be above 20% prior to drying the pet treat, but will achieve a moisture content below 20%, for example 18%, in the final pet treat product.

It should be appreciated that each of these ingredients other than the base material is optional, such as the ingredients with a percentage range starting at 0%.

After mixing the base material with the auxiliary ingredients and optionally subjecting it to a vacuum in the tumbling device, the temperature of the mixture can be checked. If the temperature is too high the mixture can be cooled, by techniques such as the addition of CO₂. Conversely, if the temperature is too low additional heat is applied to facilitate the formation of the foodstuffs mixture.

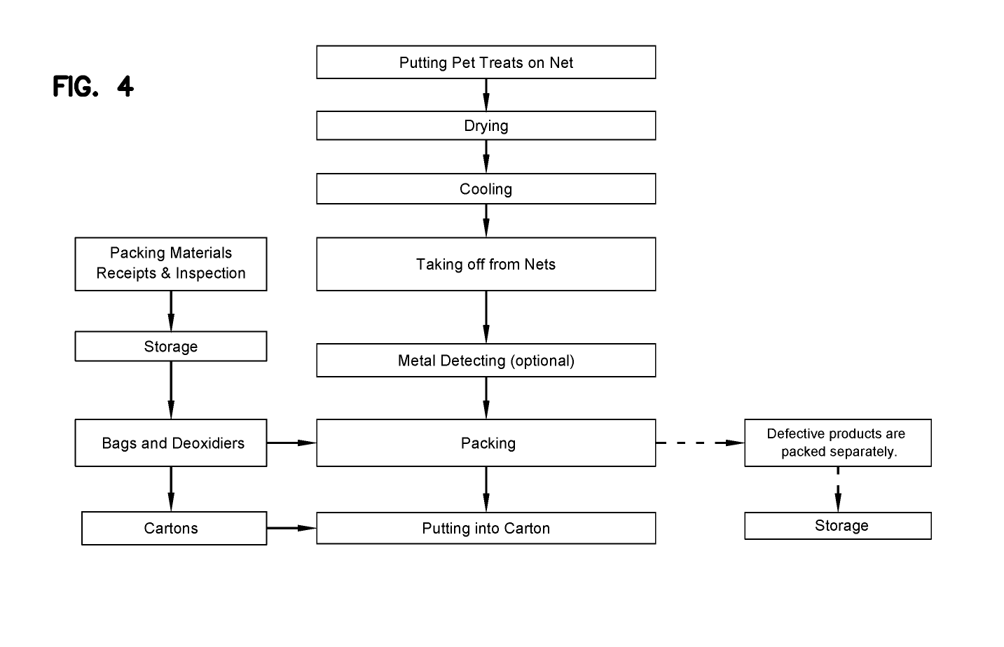

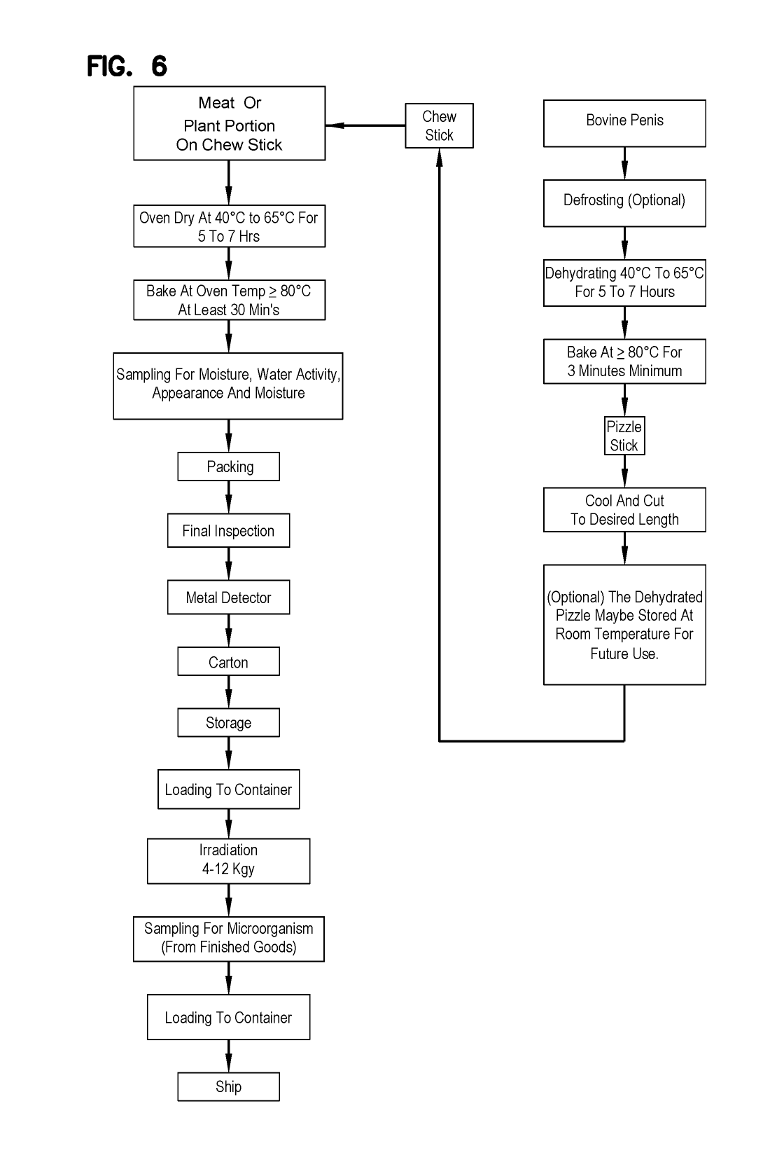

Referring now to FIGS. 4 and 6, where the foodstuffs mixture is transported to a production area and portioned. Each portion of foodstuffs mixture is positioned on the chew stick 30. FIG. 7 shows a perspective view of one or more portions 20 positioned on a chew stick 30. Although not wanting to be bound by any particular theory, the portions of foodstuffs mixture can be wrapped around chew stick in a manner that will require that a portion is pinched to remove any gaps. In an alternative embodiment the chew stick is pressed through the middle of portion, similar to placing meat or vegetables on a skewer when making shish kabobs.

In one embodiment, the portion of foodstuffs mixture may vary although portions between 0.25 inches and 1.5 inches are typical. The portions will typically range in weight, but will be between 0.25 and 4 oz. Furthermore, although the portions are generally made cylindrical in shape, the portions can be made with other shapes and conformations. For example, the geometrical shape of the base of the cylinder can be selected as desired, such as made round or flat. In addition, the portions can be shaped so as to form, generally round-shaped meat pieces (generally referred to as meatballs), cubic-shaped meat pieces, cylindrical-shaped meat pieces (for example, meat pieces resembling sausages), polygonal-shaped meat pieces, pyramid-shaped meat pieces, heart-shaped meat pieces, flat-wafer-shaped, or other more complex-shaped meat pieces.

Referring now to FIG. 4, once the desired number of portions is positioned on the chew stick, the pet treat may be moved to a surface that will form grooves on the outer surface of the portion. In this regard, the surface can be made of a number of materials. However, the materials must be compatible with the drying temperatures and duration. In one example embodiment, the surface is a net. A net allows for the weight of each pet treat to “nestle” on the netting and thus form grooves along the outer surface of the one or more portions.

The meat pieces can then be transferred via conveyor or manual transportation to a drying oven. The drying step is in an oven at about 40 degrees Celsius to about 60 degrees Celsius. In some example embodiments the drying time is at least 5 hours. In related embodiments, the drying time is between 5 to 7 hours. Additionally the pet treat may further be baked. The optional baking step is at a temperature of at least 80 degrees Celsius for at least 30 minutes. Once the baking step is finished the pet treats are removed from the oven and allowed to cool. Cold air or any other cold gas is forced on the surface which transports the pet treats from the oven to packaging. Air or gas that is warmed by contact with the pet treats is re-circulated and passed through refrigerated plates to cool the air/gas and then the air/gas is blown again over the pet treat. This process can be repeated numerous times until the pet treats are cooled to a desired temperature.

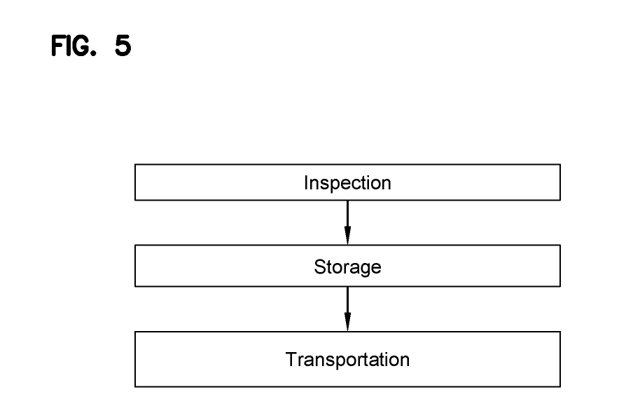

Referring now to FIGS. 5 and 6, where the cooled pet treats are removed from the surface and will have grooves along the outer surface of the one or more portions. This will give the pet treat the appearance of a grilled shish kabob. Prior to packaging, the pet treat may undergo a variety of quality control measures to detect for metal and microbial activity in the finished product. For example, prior to packaging, the pet treats can be sent through a metal detection device. If the presence of metal is detected in the pet treats, the contaminated pet treat is removed from the packaging step.

Upon removal from the netting, and optional quality control checks, the pet treats are transferred into packages. In one embodiment, air in the bags is displaced (either drawn via a vacuum or pushed with an inert gas or gas blend) so as to reduce the level of oxygen in the bags. Then the bags are filled with the pet treats and the bags are purged in an atmosphere filled with nitrogen or an inert gas such as argon, or a combination of these gases. In another embodiment, the bags are filled with the portions of pet treats in a modified atmosphere containing nitrogen, inert gas (e.g., argon), carbon dioxide, or carbon monoxide, or any combination of two or more these gases.

Any of these gasses can comprise about 0% to about 100% by weight of the gas composition. In one embodiment, the bags of pet treats comprise an atmosphere that includes nitrogen gas, carbon dioxide, and carbon monoxide. The purpose of the gas introduction is to reduce the amount of oxygen in the bag. In at least one example embodiment, the resulting pet treat is made such that it does not leave sticky or oily residue on the fingers of the pet owner or consumer who handles the pet treat. In general, typical meat or meat-based products include cooked meat with meat juice or fat may not be desirable by the pet owner or consumer. Alternatively, the pet treats described herein offer a more suitable handling. To state another way, the pet treat leaves a minimum amount of residue on the fingers of the consumer. Moreover, the one or more portions allows for a pet treat that has increased palatability and good ingredients.

For example, the addition of flour (e.g., wheat flour) can help soak up the fat content in the foodstuffs mixture, hence substantially reducing the potential of having a sticky residue when handling the pet treats. In addition, special blending techniques (e.g., vacuum blending as described in the above paragraphs) and other processes or techniques, maximize blending and reduce the occurrence of large chunks of meat in the foodstuffs mixture. The use of a dry oven with reduced humidity, as described in the above paragraphs, can produce pet treats with a substantially dry outer surface. This outer surface can form an outer dry surface to minimize the moisture from the one or more portions from bleeding out. Further, because the one or more portions are dried and the flavoring is found homogenously mixed the likelihood of transferring any dye or flavoring to a decorative surface is reduced because the dye or flavoring is less prone to contacting the decorative surface and is less prone to rub off if it does contact the decorative surface.

As shown in FIG. 7, the final product is a pet treat 10 with one or more portions 20 positioned along a chew stick 30 with the appearance of a shish kabob. Referring to the ingredients and material described above, the pet treat 10 can comprise at least one pizzle stick shaped to form a chew stick 30.

The one or more portions 20 are attached to the outside surface of the chew stick 30. If should be appreciated that the number of portions 20 placed along a chew stick will be related to consumer desire and commercial viability. However, the length of the chew stick, size of the one or more portions and proximity of the one or more portions to one another are all factors in determining the number of portions on the pet treat 10.

Still referring to FIG. 7, each of the one or more portions are positioned in a manner that provide a space between the next adjacent portion where the chew stick 30 is exposed. In some example embodiments, each of the one or more portions is positioned in a substantially equal distance from an adjacent portion. As described above, the one or more portions also comprise grooves on the outer surface.

As shown in FIG. 7, pet treat is described showing three portions. As shown, each of the three portions 20a, 20b and 20c can be made from the same foodstuffs mixture. Alternatively, pet treat can be made where at least two of the one or more portions on the pet treat 10 are from the same foodstuffs mixture formulation. In another alternative embodiment each of the one or more portions on the pet treat 10 are a different foodstuffs mixture. In a related example embodiment the three portions are pork, beef and chicken or chicken, duck and liver. However, the specific foodstuffs mixture used for each portion can be selected from a group consisting of pork, beef, chicken, duck, goat, horse, buffalo, venison, elk, moose, liver, fish, veal, lamb, turkey, goose, apple, apricot, banana, blackberry, blackcurrant, blueberry, coconut, cherry, cherimoya, date, durian, fig, feijoa, gooseberry, grape, grapefruit, jackfruit, jambul, kiwifruit, kumquat, lemon, lime, loquat, lychee, mango, mangosteen, melon, cantaloupe, honeydew, watermelon, nectarine, orange, passionfruit, peach, pear, plum, prune, pineapple, pomegranate, pommelo, raspberry, rambutan, redcurrant, satsuma, strawberry, tangerine, ugli fruit, artichoke, asparagus, avocado, bamboo shoots, bean sprouts, beans, beet, endive, bell pepper, broccoli, brussels sprouts, cabbage, calabaza, carrot, cauliflower, celery, cucumber, radish, eggplant, garlic, fiddlehead, galangal, ginger, beet greens, collard greens, dandelion greens, kale, mustard, spinach, Swiss chard, turnip greens, Jerusalem artichoke, jicama, lettuce, mushrooms, okra, onion, parsley, parsnip, peas, peppers, plantain, pumpkin, radicchio, radish, rutabaga, spinach, squash, sweet potato, tomato, turnip, water chestnut, yams, and combinations thereof.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments. Accordingly, all suitable modifications and equivalents should be considered as falling within the spirit and scope of the invention.

The above specification, examples and data provide a complete description of the manufacture and use of the composition of the invention. Since many embodiments of the invention can be made without departing from the spirit and scope of the invention, the invention resides in the claims hereinafter appended.

1. A process for making a pet treat comprising:
forming a foodstuffs mixture into portions;
positioning one or more portions on a chew stick, thereby forming a pet treat; and
drying the pet treat.

2. The process of claim 1, wherein the foodstuffs mixture comprises mixing a base material with one or more auxiliary ingredients.

3. The process of claim 2, wherein the one or more auxiliary ingredients include a binding agent, a salt, a sugar, an acid, a mold inhibitor, a flavoring, an aroma compound, a coloring compound, phytochemical or any combination of two or more thereof.

4. The process of claim 1, wherein the drying is in an oven at about 40 degrees Celsius to about 60 degrees Celsius.

5. The process of claim 1, wherein the drying time is at least 5 hours.

6. The process of claim 1, wherein the drying time is between 5 to 7 hours.

7. The process of claim 4, further comprising baking the pet treat.

8. The process of claim 7, wherein the baking step is at a temperature of at least 80 degrees Celsius.

9. The process of claim 8, wherein the baking is for at least 30 minutes.

10. The process of claim 1, further comprising the step of packing a plurality of pet treats in a container.

11. The process of claim 1, wherein the chew stick is formed by soaking rawhide in a potassium sorbate solution, twisting the rawhide, thereby forming a chew stick and drying the chew stick at 40 degrees Celsius to 65 degrees Celsius.

12. The process of claim 11, wherein the concentration of potassium sorbate is 0.5% v/v.

13. The process of claim 1, wherein the drying time of the chew stick prior to having the one or more portions attached thereto is at least about 4 hours.

14. The process of claim 1, wherein the positioning step comprises wrapping the one or more portions around the chew stick.

15. The process of claim 1, wherein the one or more portions, comprises at least three portions and wherein each of the at least three portions are positioned substantially equal distance from the adjacent portion(s).

16. The process of claim 2, wherein the base material comprises a meat selected from a group consisting of pork, beef, chicken, duck, goat, horse, buffalo, venison, elk, moose, liver, fish, veal, lamb, turkey, goose and combinations thereof.

17. The process of claim 2, wherein the base material comprises a plant selected from a group consisting of apple, apricot, banana, blackberry, blackcurrant, blueberry, coconut, cherry, cherimoya, date, durian, fig, feijoa, gooseberry, grape, grapefruit, jackfruit, jambul, kiwifruit, kumquat, lemon, lime, loquat, lychee, mango, mangosteen, melon, cantaloupe, honeydew, watermelon, nectarine, orange, passionfruit, peach, pear, plum, prune, pineapple, pomegranate, pommelo, raspberry, rambutan, redcurrant, satsuma, strawberry, tangerine, ugli fruit and combinations thereof.

18. The process of claim 2, wherein the base material comprises a plant selected from a group consisting of artichoke, asparagus, avocado, bamboo shoots, bean sprouts, beans, beet, endive, bell pepper, broccoli, brussels sprouts, cabbage, calabaza, carrot, cauliflower, celery, cucumber, radish, eggplant, garlic, fiddlehead, galangal, ginger, beet greens, collard greens, dandelion greens, kale, mustard, spinach, Swiss chard, turnip greens, Jerusalem artichoke, jicama, lettuce, mushrooms, okra, onion, parsley, parsnip, peas, peppers, plantain, pumpkin, radicchio, radish, rutabaga, spinach, squash, sweet potato, tomato, turnip, water chestnut, yams, and combinations thereof.

19. The process of claim 1, further comprising the step of placing the pet treat on a surface prior to drying, wherein the surface forms grooves on the outer layer of the one or more portions.

20. A process for making a pet treat, the steps comprising:
forming a foodstuffs mixture into portions;
positioning one or more portions on a chew stick, thereby forming a pet treat, wherein the one or more portions are positioned on the external surface of the chew stick;
placing the pet treat on a net, wherein the net forms grooves on the outer surface of the one or more portions;
drying the pet treat in an oven at about 40 degrees Celsius to about 60 degrees Celsius for at least 5 hours;
baking the pet treat at a temperature of at least 80 degrees Celsius for at least 30 minutes; and
packing a plurality of pet treats in a container.

21. A pet treat comprising:
at least one pizzle stick section shaped to form a chew stick and
one or more portions, wherein the one or more portions are disposed on the outside surface of the chew stick.

22. The pet treat of claim 21, wherein the one or more portions comprises a foodstuffs mixture which comprises a base material with one or more auxiliary ingredients.

23. The pet treat of claim 21, wherein the one or more auxiliary ingredients include a binding agent, a moisturizing compound, a salt, a sugar, an acid, a mold inhibitor, a flavoring compound, an aroma compound, a coloring compound and any combination of two or more thereof.

24. The pet treat of claim 21, wherein each of the one or more portions on the pet treat is made from the same foodstuffs mixture formulation.

25. The pet treat of claim 21, wherein at least two of the one or more portions on the pet treat are from the same foodstuffs mixture formulation.

26. The pet treat of claim 21, wherein each of the one or more portions on the pet treat are a different foodstuffs mixture formulation.

27. The pet treat of claim 22, wherein the base material comprises a meat selected from a group consisting of pork, beef, chicken, duck, goat, horse, buffalo, venison, elk, moose, liver, fish, veal, lamb, turkey, goose and combinations thereof.

28. The pet treat of claim 22, wherein the base material comprises a plant selected from a group consisting of apple, apricot, banana, blackberry, blackcurrant, blueberry, coconut, cherry, cherimoya, date, durian, fig, feijoa, gooseberry, grape, grapefruit, jackfruit, jambul, kiwifruit, kumquat, lemon, lime, loquat, lychee, mango, mangosteen, melon, cantaloupe, honeydew, watermelon, nectarine, orange, passionfruit, peach, pear, plum, prune, pineapple, pomegranate, pommelo, raspberry, rambutan, redcurrant, satsuma, strawberry, tangerine, ugli fruit, artichoke, asparagus, avocado, bamboo shoots, bean sprouts, beans, beet, endive, bell pepper, broccoli, brussels sprouts, cabbage, calabaza, carrot, cauliflower, celery, cucumber, radish, eggplant, garlic, fiddlehead, galangal, ginger, beet greens, collard greens, dandelion greens, kale, mustard, spinach, Swiss chard, turnip greens, Jerusalem artichoke, jicama, lettuce, mushrooms, okra, onion, parsley, parsnip, peas, peppers, plantain, pumpkin, radicchio, radish, rutabaga, spinach, squash, sweet potato, tomato, turnip, water chestnut, yams, and combinations thereof.

29. The pet treat of claim 21, wherein the one or more portions comprise grooves on the outer surface.

30. The pet treat of claim 21, wherein the at least one pizzle stick section is soaked in a potassium sorbate solution prior to forming said chew stick.

31. The pet treat of claim 30, wherein the concentration of potassium sorbate is 0.5% v/v.

32. The pet treat of claim 21, wherein the one or more portions are wrapped around the chew stick.

33. The pet treat of claim 21, wherein the one or more portions, comprises at least three portions and wherein each of the at least three portions are positioned substantially equal distance from an adjacent portion(s).

34. The pet treat of claim 21, wherein the at least one pizzle stick section comprises two pizzle stick portions.

35. The pet treat of claim 21, wherein the pet treat comprises one or more coloring compounds selected from a group consisting of caramel coloring, malliouse, allura red AC, annatto, astaxanthin, betanin or beetroot red, blue 2, brilliant black BN, brilliant blue FCF, brown FK, canthaxanthin, carmine, carotene, Color Blue, curcumin, erythrosine, orange number 1, iron oxide, orange B, ponceau 6R, red 40, red 2G, saffron, sunset yellow FCF, tartrazine, titanium dioxide, turmeric, yellow 5, yellow 2, or any combination of two or more thereof.

36. The pet treat of claim 21, wherein the at least one pizzle stick section comprises two pizzle stick portions that are twisted together.

37. The pet treat of claim 36, wherein each of the two pizzle stick portions are from a different animal source.

38. The pet treat of claim 21, wherein the one or more portions comprises at least three portions and wherein each of the portions comprises a foodstuffs mixture comprising a base material with one or more auxiliary ingredients and wherein each of the one or more portions on the pet treat are a different foodstuffs mixture formulation and wherein the pet treat comprises portions each having one of pork, beef and chicken or chicken, duck and liver.

39. The pet treat of claim 21, wherein the plurality of portions are positioned on the external surface of the chew stick.

40. The pet treat of claim 21, wherein the pet treat is in a lollipop form.
